(19) United States
(12) Patent Application Publication
(10) Pub. No.: US 2019/0080372 A1
(43) Pub. Date: Mar. 14, 2019

(54) Targeted Reviews

(71) Applicant: Steve Richardson, Tampa, FL (US)

(72) Inventor: Steve Richardson, Tampa, FL (US)

(21) Appl. No.: 16/180,914

(22) Filed: Nov. 5, 2018

Related U.S. Application Data
(63) Continuation-in-part of application No. 15/381,335, filed on Dec. 16, 2016.

(51) Int. Cl. G06Q 30/02; G06F 17/30

(52) U.S. Cl. CPC G06Q 30/0282; G06F 17/30283

(57) ABSTRACT

A system for targeted reviews includes a review server that hosts the reviews. When review data is requested by a requester, the review server requests a list of contacts of the requester. The review server then creates and presents a subset of the reviews that relate to the request and were written by those on the list of contacts. The list of contacts is extracted from a contact list of the requester, either stored locally on the requesting device or at a server. In this way, the requester is able to see reviews that were written by those in the requestor's contact list. In some embodiments in which the system has access to contacts of each of the contacts, a second level list is envisioned including reviews of contacts and reviews of contact of the contacts.

### CROSS-REFERENCE TO RELATED APPLICATION

This application is a continuation in part of U.S. patent application Ser. No. 15/381,335, filed Dec. 16, 2016, the disclosure of which is hereby incorporated by reference.

### FIELD

This invention relates to contact lists and more particularly to a system for providing reviews related to those in your contact list.

### BACKGROUND

Nowadays, almost everybody has a smartphone. Many use their smartphone for messaging, email, taking pictures, etc., but in reality, the birth of the smartphone came from early cellular phones that provided only voice communications. Each smartphone has a unique phone number; unique world-wide when the country code is included.

As people often find it easier to remember a person's or an establishment's name as opposed to a ten-digit phone number, phone directories came about just as in the past, phone books and rotary phone indexes were used for landline phones. The concept was initially simple—an entry (e.g. card or record) was indexed by the person's or establishment's name and contained an address and phone number of the person or establishment.

As smartphones became popular, similar systems were created through software on the smartphones. Such “phonebooks” are used mostly to store records containing phone numbers of people and establishments that are commonly called. These phonebooks are typically indexed by the person's or establishment's name or alias such as “mom,” “dad,” “Joe's Pizzeria,” etc. This made using smartphones much easier as both voice calling and messaging is now directed, for example, to “mom.”

As capabilities and storage of smartphones increased, more information has been stored in each user's phonebook, including addresses, birthdates, anniversaries, personal information, work/office information, vehicle identification numbers, etc.

Everybody who has a smartphone has a phone book, but in general, all phonebook entries are entered manually (at least initially) or through various automated schemes such as scanning of business cards using the smartphone's camera or electronic transfer from one phone to another phone using virtual business cards (e.g. VCF). In such, when a new smartphone is purchased, the phonebook must be transferred from the old smartphone to the new smartphone as storage for the phonebook records was within the memory of the user's smartphone.

Being that phonebook records are created manually, data accuracy depends upon whoever enters the data; usually using the smartphone's on-screen keyboard and limit display size. This often leads to errors, duplicate entries, etc. Further, certain complexities are often overlooked by users such as multiple phone number entries for home, office, cell, etc., making difficult to determine which number to call at a later time.

Updating locally stored phonebook records is also a tenuous ordeal. When one of your contacts changes their phone number, email address, name (e.g. after marriage), address, etc., that person usually sends out a message to everybody in their phonebook requesting that everybody make updates. This is not an easy task since there are many records in one's phonebook that are one-way (e.g. calls are only made to a restaurant, not from the restaurant), many records are not up-to-date (e.g. the phone number is wrong), and some records one does not want to send requests for updates (e.g. ex-girlfriend or ex-boyfriend). If the contact information in your phonebook is outdated, you cannot inform that person of your new contact information and will likely lose touch with that person.

Personal phonebook records become the property of the smartphone owner, in that, once created, it is up to the smartphone owner to guard the information and there is no way to limit the life of the information in any way except to ask the smartphone owner to delete your information.

In addition, smartphone records are flat. If you give someone your business card or VCF, that person gets all of the information on your business card or VCF. For paper business cards, if you do not want that person to have your cellular number, you have to blackout that part of the business card, but once provide to the person, there is no taking it back.

Given the fact that many people have elaborate contact lists of people they know and, presumably trust, there exists a wealth of data created by those people on a person's contact list. One such creation is a set of reviews by those people on the person's contact list. Unfortunately, with currently technology, when one visits a web site that has review information, that site presents reviews from all reviewers. There is no correlation to viewers that are in some way related to the requester of the reviews.

What is needed is a system that will provide review data honed to those that are related to the requester through the requestor's contact list.

### SUMMARY

A system for providing management of contact records includes a single record that is primarily indexed by phone number. The contact records are network accessed through any of various cellular and data networks by various devices and cached locally on such devices by way of permission from the owner of each record. In this way, the owner of each record has the ability to deny access to some or all of the information stored in the contact record at any time. As changes are made to a contact record, all others that have access to that contact record receive updated information. Duplicates are eliminated as no two individuals or establishments share the same phone number.

In one embodiment, a system for targeted reviews includes a requester device, the requester device having access to a plurality of contact records, each contact record comprising identification data of a contact. The system includes a web site having review information. Software running on the requester device browses to the web site and requests review data. The web site sends a query to the software running on the requester device; the query requests a list of identification data from the plurality of contact records. The software running on the requester device responds by sending the list of identification data to the web site and the web site presents a subset of the review data; the subset of the review data being reviews associated with those in the list of identification data.

In another embodiment, a method for targeted reviews includes at a requester device, requesting a review from a web site. The web site is in communication with the requester device through a network. The web site responds by requesting a list of identification data. In response, the list of identification data is extracted from a set of contact records and the list of identification data is sent to the web site. The web site accesses review data and presents a subset of the review data, the subset of the review data being reviews associated with those in the list of identification data.

In another embodiment, program instructions tangibly embodied in a non-transitory storage medium comprising at least one instruction for a system for targeted reviews includes computer readable instructions running on a requester device for sending a request for a review from a web site. Further, computer readable instructions running on the web site, after receiving the request for the review, send a request for a list of identifications (e.g., either to the requesting device or to a third party server). Computer readable instructions running on web site, after receiving the list of identifications, access review data related to the request for the review (e.g., review data for a product, service, movie, other content, etc.). Computer readable instructions running on the web site then create a subset of review data related to the request for the review. The subset of the review data being reviews associated with those in the list of identifications and sending the subset of the review data to the requester device. Finally, computer readable instructions running on the requester device displays the subset of the review data.

In another embodiment, a system for targeted reviews includes a requester device and a sever for managing contacts. The server has a plurality of contact records, each contact record including identification data. A review server has access to a plurality of reviews. Software running on the requester device accesses the review server and requests a subset of the reviews related to a subject. The review server sends a query to software running on the server requesting a list of identification data from a subset of the plurality of contact records that are contacts of the requester device. The software running on the server finds the subset of the plurality of contact records that are contacts of the requester device and responds by sending identification data from each contact record in the subset of the plurality of contact records that are contacts of the requester device. The review server sends the requester device the subset of the reviews related to the subject processed using the list of identification data from each contact record in the subset of the plurality of contact records that are contacts of the requester device and the requester device displays the subset of the reviews related to the subject processed using the list of identification data from each contact record in the subset of the plurality of contact records that are contacts of the requester device.

In another embodiment, a method for targeted reviews includes a user at a device requesting a review related to a subject. The device sending a request for the review to a review server through a network. Responsive to that, the review server requesting a list of identification data from a server having access to a set of contact records that are contacts of the user. The server then extracting the list of identification data from a set of contact records and sending the list of identification data to the review server. The review server generating a subset of the review data related to the subject, sorted/marked/filtered according to the list of identification data and the review server sending the review data related to the subject according to the list of identification data to the device for display.

In another embodiment, program instructions tangibly embodied in a non-transitory storage medium comprising at least one instruction for a system for targeted reviews includes computer readable instructions running on a requester device for sending a request for a review related to a subject of a review server. Computer readable instructions running on the review server, after receiving the request for the review, send a request for a list of identifications to a server having access to contact records related to the requester device. After receiving the list of identifications, computer readable instructions running on review server generate a subset of reviews related to the subject and authored by contacts from the list of identifications and send the subset of reviews to the requester device. Responsive, computer readable instructions running on the requester device display the subset of the reviews related to the subject and authored by contacts.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for common contact management.

FIG. 2 illustrates a schematic view of a typical smartphone.

FIG. 3 illustrates a schematic view of a typical computer system such as a server or personal computer.

FIG. 4 illustrates a smartphone user interface of the prior art.

FIGS. 5 and 5A illustrate exemplary smartphone user interfaces for initiating contact between two users in the system for common contact management.

FIGS. 6, 6A, and 6B illustrate exemplary user interface for accepting a contact in the system for common contact management.

FIG. 7 illustrates another exemplary user interface initiating contact between two users the system for common contact management.

FIG. 8 illustrates an exemplary user interface for initiating contact between two users of the system for common contact management.

FIG. 9 illustrates an exemplary user interface initiating contact between two users of the system for common contact management.

FIG. 10 illustrates an exemplary user interface initiating contact between two users of the system for common contact management.

FIG. 11 illustrates an exemplary user interface for displaying/searching contacts using the system for common contact management.

FIG. 11A illustrates an exemplary annotation user interface of the system for common contact management.

FIG. 11B illustrates an exemplary user interface for connecting two contacts using the system for common contact management.

FIG. 12 illustrates an exemplary user interface for entering contact information into the system for common contact management.

FIG. 12A illustrates an exemplary user interface for reviewing feedback of an establishment using data from the system for common contact management.

FIG. 12B illustrates an second exemplary user interface for reviewing feedback of an establishment using data from the system for common contact management.

FIGS. 13, 13A and 13B illustrate exemplary sets of contact records of the system for common contact management.

FIG. 14 illustrates an exemplary user interface for displaying contacts from an association using the system for common contact management.

FIG. 14A illustrates an exemplary user interface for displaying loyalty points of the system for common contact management.

FIG. 15 illustrates a connected data graph of the system for common contact management.

FIG. 16 illustrates an exemplary program flow of the system for common contact management m.

FIG. 17 illustrates a second exemplary program flow of the system for common contact management.

FIG. 18 illustrates a third exemplary program flow of the system for common contact management.

FIG. 19 illustrates a fourth exemplary program flow of the system for common contact management.

FIG. 20 illustrates a fifth exemplary program flow of the system for common contact management.

FIG. 21 illustrates an exemplary program flow for generating reviews based upon those in a contact list.

FIG. 22 illustrates a transaction flow diagram using the system for common contact management in conjunction with a system having reviews.

FIG. 23 illustrates a program flow diagram using the system for common contact management in conjunction with a system having reviews.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “contact record,” describes a data record that is stored/transferred containing information typically for providing phonebook contacts and other uses. The primary key to finding the contact record is a telephone number and other information is stored in this record. Some exemplary data that is stored in each phonebook records includes, but is not limited to, the name associated with the telephone number (e.g. a person's name or establishment name), personal information (e.g., home address, date-of-birth), business information (e.g., business address), personal information (likes, hobbies, favorites), etc. It is fully anticipated that in some embodiments, less information is stored in some or all phonebook records, minimally the phone number and name, the additional information being optional.

The description uses the term initiator as a user who initiates sharing of contact information and uses the term recipient as a user who receives the contact information, though these titles are used for description purposes only.

Throughout this description, the initiator provides access to the initiator's contact record to the recipient, though it is anticipated that the recipient will then reciprocate and provide access to the recipient's contact record to the initiator. Note that in some examples throughout this description, it is cited that the recipient receives access to the initiator's contact record. This is fully anticipated to be any subset of the initiator's contact record or the entire initiator's contact record, even though not explicitly stated.

The description uses the term, “requester,” for a person that requests review information.

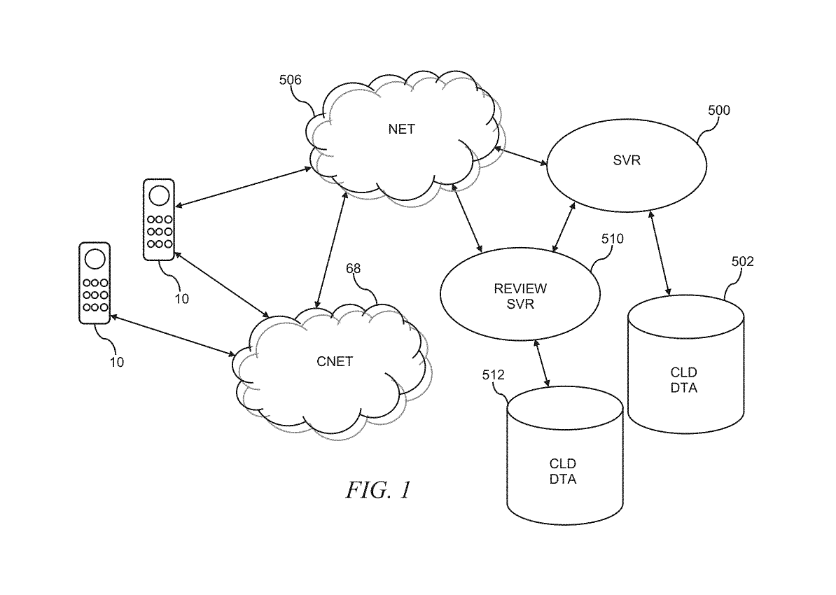

Referring to FIG. 1 illustrates a data connection diagram of the exemplary system for common contact management. In this example, one or more devices such as smartphones 10 communicate through the cellular network 68 and/or through a wide area network 506 (e.g. the Internet) to a server computer 500.

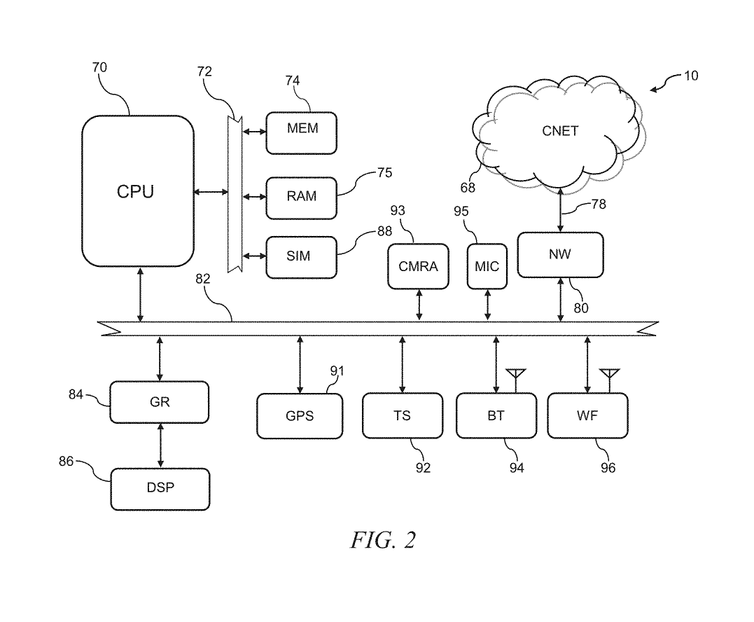

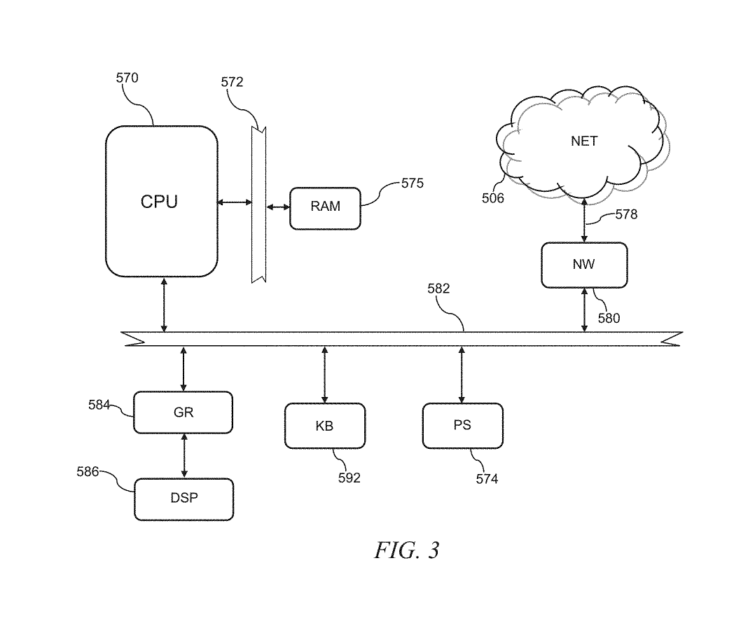

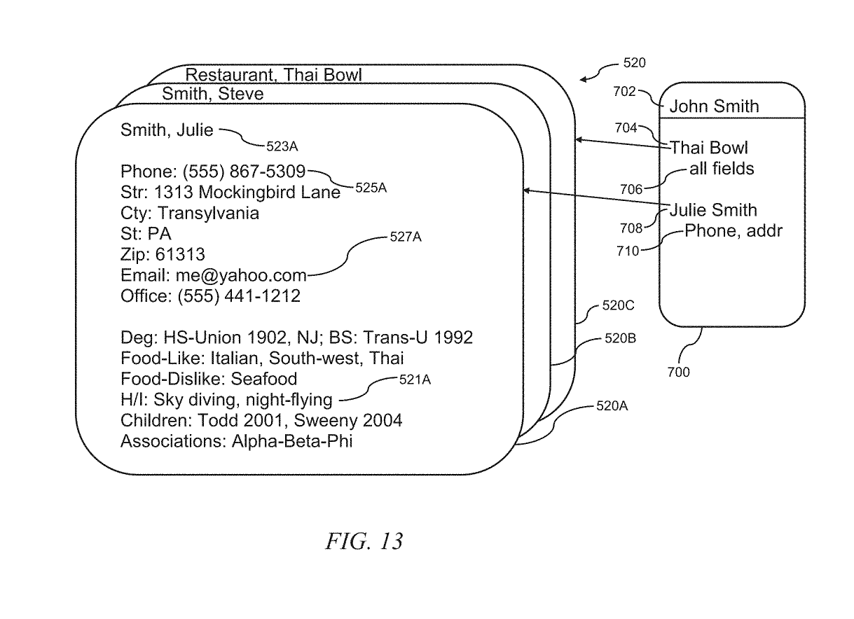

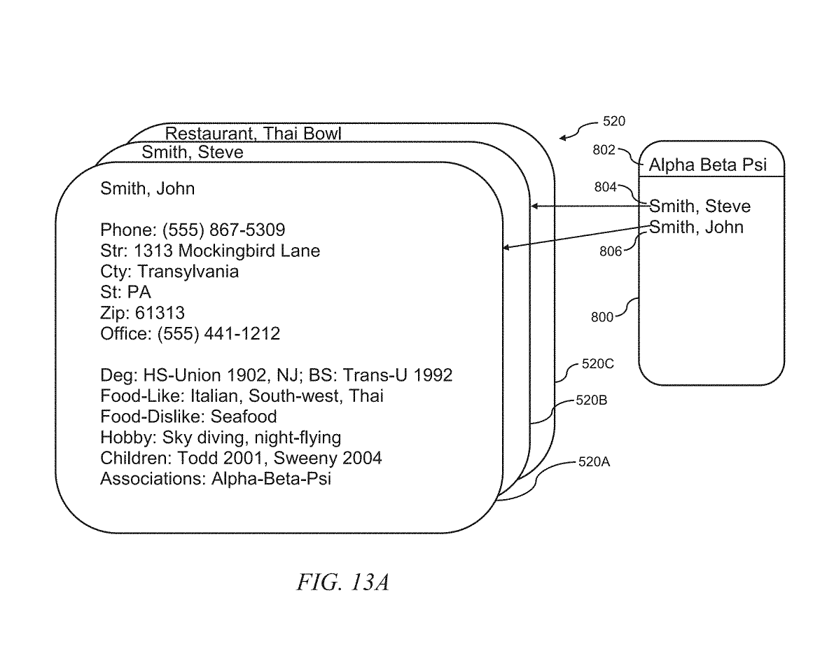

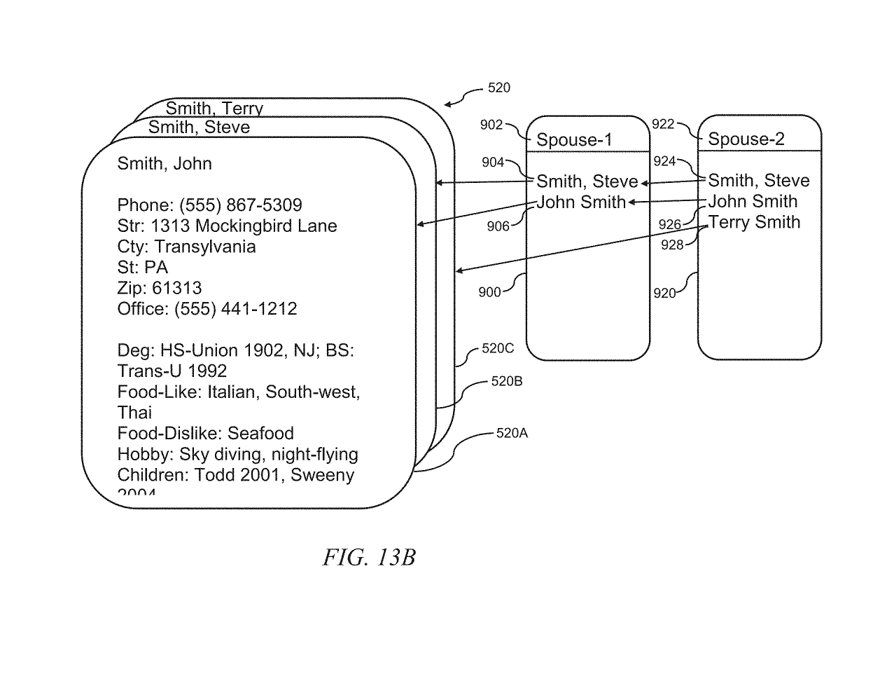

The server computer 500 has access to data storage 502 (e.g. “cloud” storage) that is used to store contact records 520 (see FIG. 13). Although one path between the smartphones 10 and the server 500 is shown going through the cellular network 68 and the wide area network 506 as shown, any known data path is anticipated. For example, the Wi-Fi transceiver 96 (see FIG. 2) of the smartphone 10 is used to communicate directly with the wide area network 506, which includes the Internet, and, consequently, with the server computer 500.

The server computer 500 transacts with software running on the smartphones 10 through the network(s) 68/506. The software (e.g., an application) presents menus to/on the smartphones 10, provides data to the smartphones 10, and communicates information to/from the server such as new contact records 520.

The server computer 500 transacts with an application running on the smartphones 10 as needed, for example, when downloading a new contact (contact record 520—see FIG. 13) or updating an existing contact record 520. In some areas, smartphone access is sporadic and, being such, the application running on the smartphone downloads and caches a subset of contact records 520.

In some embodiments, when the phonebook application runs on the smartphone 10, the geographic area of the smartphone 10 is determined by reading the GPS subsystem 91 (see FIG. 2) of the smartphone 10 or by triangulation with several cellular towers. In some embodiments, the location (e.g. from the GPS subsystem 91) is used to enhance the usability of the smartphone 10. For example, when at home, different contact records 520 are highlighted/presented than when at work, etc.

In FIG. 1, an exemplary data connection diagram of the system for common contact management is shown. The system for common contact management, for example, includes a server 500 that transacts with one or more end user devices (e.g. smartphones 10) to manage contact records 520.

The system for common contact management stores contact records 520 (see FIGS. 13, 13A, 13B) in a contact records database 552 (e.g. in a disk 502 that is local to the server 500, cloud-based storage, etc.). In this example, contact records 520 or partial contact records 520 are communicated between the server 500 and end-user devices (e.g. smartphones 10) through a network 68/506. Any network topology and composition is fully anticipated including only a data network 508 (e.g. the Internet) or only the cellular network 68 (e.g. sending contact records using Short Message Services—SMS).

Referring to FIG. 2, a schematic view of a typical end-user device, a smartphone 10 is shown. Although any end-user device is anticipated, for clarity purposes, a smartphone 10 will be used in the remainder of the description.

The system for common contact management is described using a processor-based end-user device (e.g., smartphone 10) for providing the login and user interfaces necessary for managing contact information and using a phonebook having access to contact records 520, for example, to place a call. The present invention is in no way limited to using a smartphone 10 and any similar device is anticipated (e.g., cellular phone, portable digital assistant, tablet, notebook, etc.).

The example smartphone 10 represents a typical device used for accessing user interfaces of the system for common contact management. This exemplary smartphone 10 is shown in its simplest form. Different architectures are known that accomplish similar results in a similar fashion and the present invention is not limited in any way to any particular smartphone 10 system architecture or implementation. In this exemplary smartphone 10, a processor 70 executes or runs programs in a random access memory 75. The programs are generally stored within a persistent memory 74 and loaded into the random access memory 75 when needed. Also accessible by the processor 70 is a SIM (subscriber information module) card 88 having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary smartphones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the SIM card 88 is used to store programs, executable code, cached contact records 520, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, camera 93, microphone 95, Bluetooth transceiver 94, Wi-Fi transceiver 96, image sensors, temperature sensors, etc., the details of which are not shown for brevity and clarity reasons.

The cellular network interface 80 connects the smartphone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the smartphone 10 through the cellular network 68.

For local communications, many smartphones 10 include a Bluetooth transceiver 94, a Wi-Fi transceiver 96, or both. Such features of smartphones 10 provide data communications between the smartphones 10 and data access points and/or other computers such as a personal computer (not shown).

Referring to FIG. 3, a schematic view of a typical computer system (e.g., server 500) is shown. The example computer system 500 represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 (e.g., disk storage) is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, data, contact records 520, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

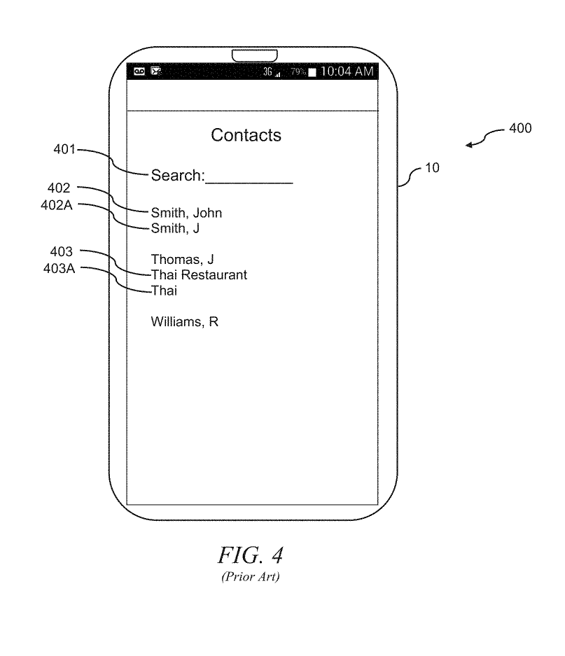

Referring to FIGS. 4, a representative phonebook interface 400 of the prior art is shown. As with many such interfaces, the phonebook interface 400 of the prior art includes a search feature 401 which is especially useful when the phonebook has many records. In the prior art, many phonebook records were entered manually. As a result, this user interface shows some redundant records such as records for John Smith 402 and J. Smith 402A and records for a Thai Restaurant 403 and simply “Thai” 403A, among other records. As a user creates new phonebook records in the phonebook interface 400 of the prior art, there is no checking to see if a record already exists and, therefore, both of the above pairs or records 402/402A/403/403A likely represent only two entities, John Smith and a Thai Restaurant. Since the phonebook of the prior art is organized and keyed by the name of the person/establishment, there can be many entries having the same phone number. For example, the record for John Smith 402 and J smith 402A likely have the same phone number.

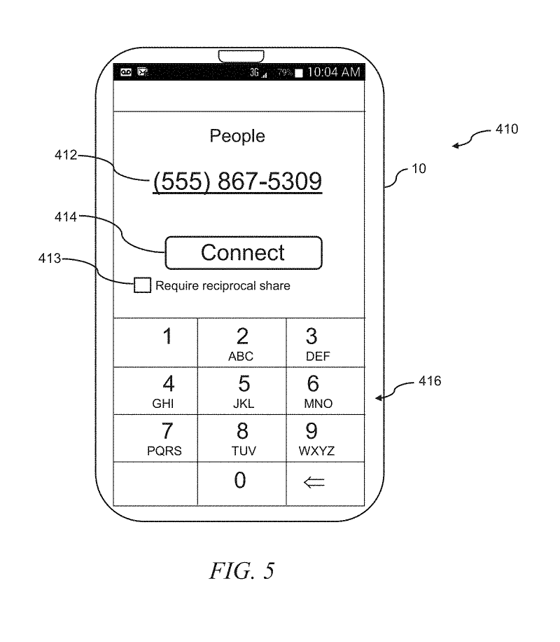

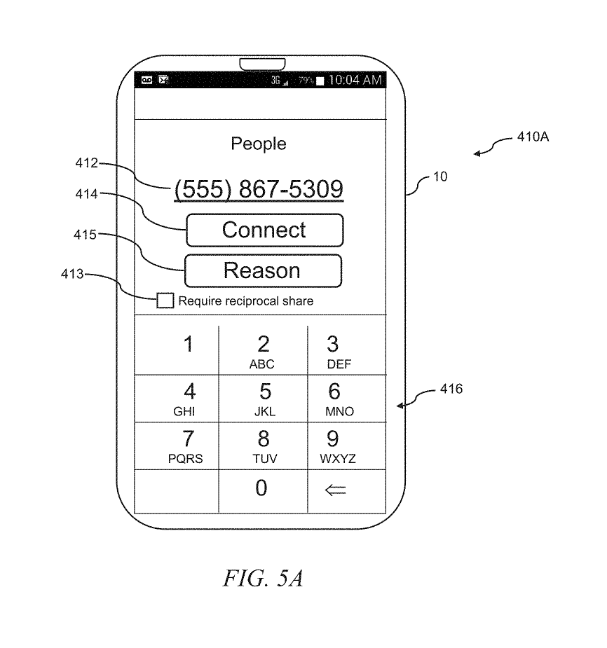

Referring to FIGS. 5-12A, exemplary user interfaces of the system for common contact management are shown. Although many user interfaces are anticipated, one set of examples are shown for brevity reasons. Some of the user interfaces utilize a browser running on the user device (e.g., a computer as shown in FIG. 3), while some of the examples shown are generated/managed by an application that runs on the user device (e.g. smartphone 10). Again, for brevity, in the remainder of the description, the user device will be referenced as a smartphone 10.

When an initiator desires to share contact information with a recipient, the initiator (having already configured and downloaded the contact management application) initiates the contact management application and navigates to a request user interface 410 as shown in FIGS. 5 and 5A. In the request user interface 410 of FIG. 5, the initiator has entered the phone number 412 of the recipient using, for example, an on-screen numeric keypad 416. In FIG. 5A, the user interface 410A includes a reason field 415 that is either free form or a selection of reasons (e.g., connect for business reasons, connect for personal reasons, connect for dating). Once the phone number 412 is entered (and optionally the reason field 415), the initiator invokes the connect feature 414.

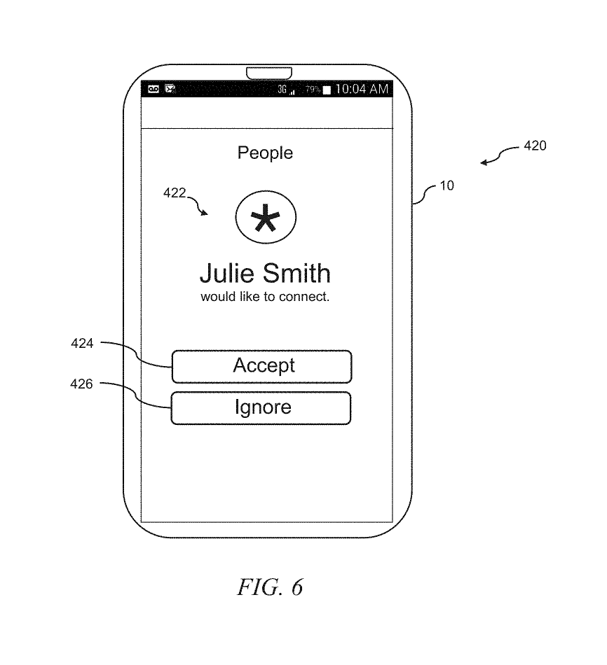

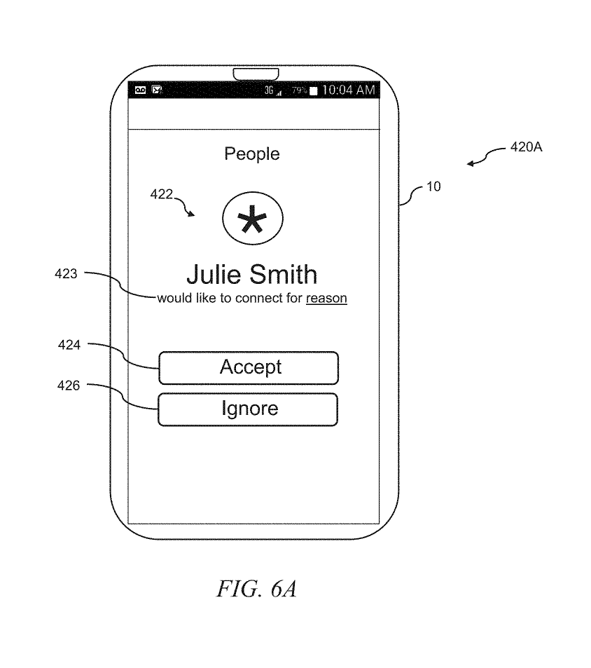

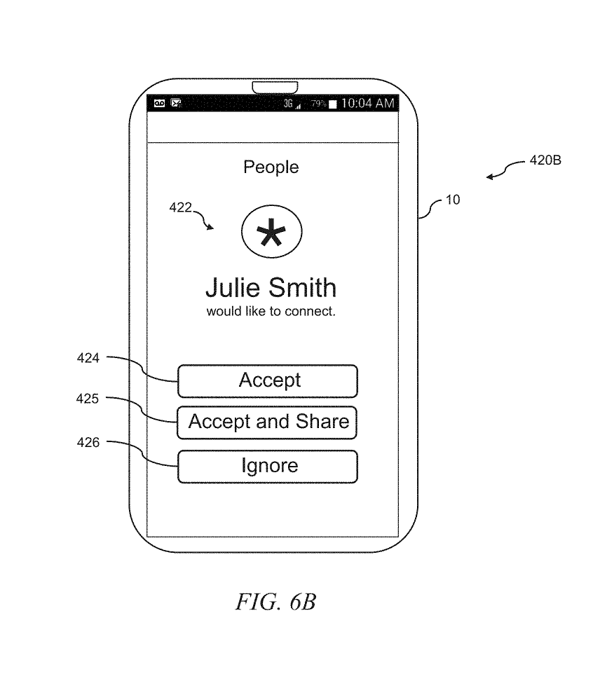

In some embodiments, a flag or field for reciprocal sharing 413 is provided. Reciprocal sharing means that the recipient will not receive the initiator's contact information until the recipient shares his or her own contact information with the initiator. In such, the recipient receives the request to connect as in FIG. 6B, but does not have the option to accept using the accept directive 424—the recipient must accept using the accept and share directive 425. In some embodiments the initiator has user interface features that set minimum share-back requirements when reciprocal sharing is used. For example, requiring the recipient to share at least the recipient's phone number and email address.

If the recipient has not previously loaded the contact management application on their smartphone 10, the recipient receives a text message including a link to download the contact management application along with text saying the name of the initiator that wants to connect to them.

If the recipient had previously loaded the contact management application or after the loading is complete, the recipient is presented a query user interface 420/420A/420C as shown in FIGS. 6, 6A, and 6B.

In FIGS. 6 and 6A, exemplary accept user interfaces 420/420A are shown. A description of the person 422 desiring to connect is displayed (e.g., the first person's name, picture, phone number, etc.) and options to accept the connection 424 or ignore the request 426. In FIG. 6A, the accept user interface 420A includes a reason 423 that the initiator wishes to connect, which is useful in examples such as when the recipient does not know or has not met the initiator. In some embodiments, if the recipient selects accept the connection 424, the recipient receives access to at least a portion of the initiator's contact record 520 from the storage 502. In some embodiments, if the recipient selects accept the connection 424, the recipient receives access to at least a portion of the initiator's contact record 520 from the storage 502 in exchange for sharing the recipients contact record 520 with the initiator.

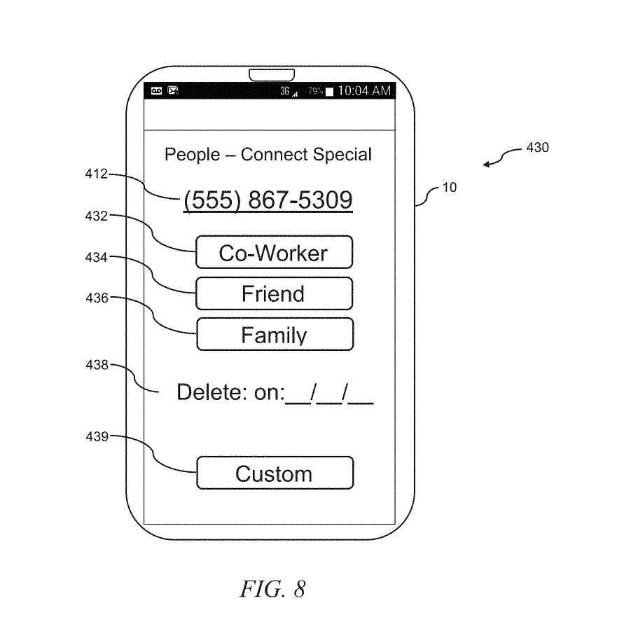

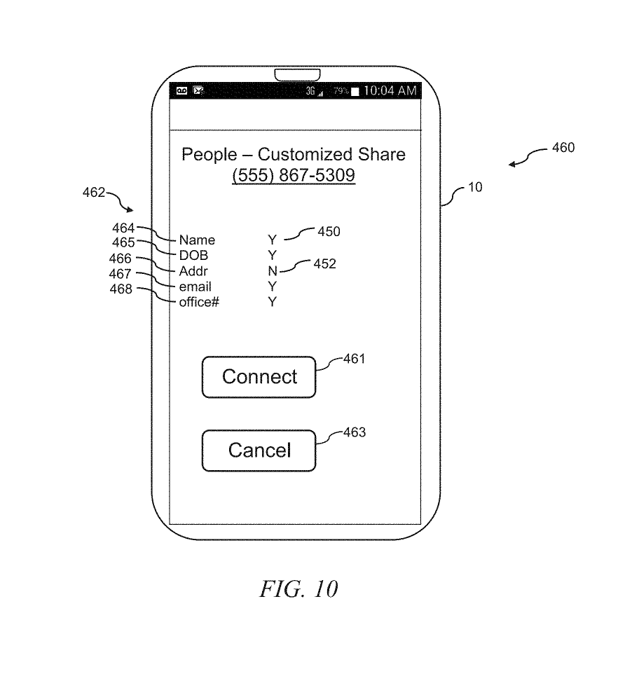

In FIG. 6B, the exemplary accept user interface 420B is shown. This accept user interface 420B is similar to those previously described, having the description of the person 422 desiring to connect is displayed (e.g., the first person's name, picture, phone number, etc.) and options to accept the connection 424 or ignore the request 426. As with the accept user interface 420A of FIG. 5A, in some embodiments the accept user interface 420B also includes a reason 423 that the initiator wishes to connect. If the recipient selects accept the connection 424, the recipient receives access to at least a portion of the initiator's contact record 520 from the storage 502. In this accept user interface 420B, an additional feature is provided as an accept/share directive 425. By invoking the accept/share directive 425, the recipient is providing their own contact information (or subset thereof) back to the initiator. It is fully anticipated that the accept/share directive 425 will provide either a default set of contact information that is to be shared with the initiator. In some embodiments, the recipient is provided with user interfaces 430/460 as in FIGS. 8 and 10 for selecting what sections/items of the initiator's contact is to be shared with the initiator.

As with the initiator sharing contact information with the recipient, the recipient has the ability to later restrict, limit, or inhibit any or all access of the recipient's contact record to the initiator.

Note that the request user interface 410 interface is simplified for clarity reasons as when the initiator invites the recipient, the initiator typically has selection criteria (as will be discussed) to limit which portions of the initiator's contact record 520 is accessible by the recipient (e.g. only phone number, name, and address, not personal information, work information, etc.). Likewise, in the accept user interface 420, it is anticipated that there will be directives to provide the recipient's contact record 520 along with directives to limit which portions of the recipient's contact record 520 is accessible to the initiator (e.g. only phone number, name, and address, personal information, work information, etc.).

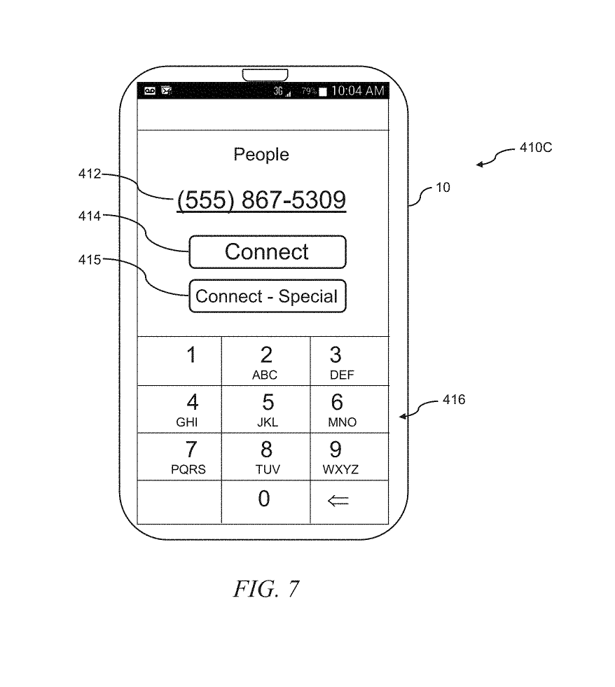

In FIG. 7, a slightly different request user interface 410C is shown. In this request user interface 410C of FIG. 7, the initiator has entered the phone number 412 of the recipient using, for example, an on-screen numeric keypad 416. Once the phone number 412 is entered, the initiator invokes either the connect feature 414 (taking the default permissions) or the connect-special feature 415, allowing the initiator to select what sections of the initiator's contact is to be shared with the recipient.

Upon invoking the connect-special feature 415, the connect-special user interface 430 as shown in FIG. 8 is presented, carrying forward the recipient's phone number 412. In the connect-special user interface 430, the initiator has selections to provide contact data to a co-worker 432, to a friend 434, or to a family member 436. For example, the contact data provided to a co-worker only contains work phone number and office location while the contact data provided to a family member contains phone number, cellular number, address, date-of-birth, etc.

As will be shown, the initiator can revoke the recipient's access to any contact information that has been provided at any time. In addition, the initiator has the ability to change what information if provided to the recipient at any time (e.g., upgrade/downgrade relationship). In certain security/privacy scenarios, the initiator is able to set a date (or date/time) 438 for the deletion of the contact data that is accessible by the recipient. The date 438 is when the recipient will lose access to whatever contact data is provided or, in some embodiments, whatever additional contact information is provided.

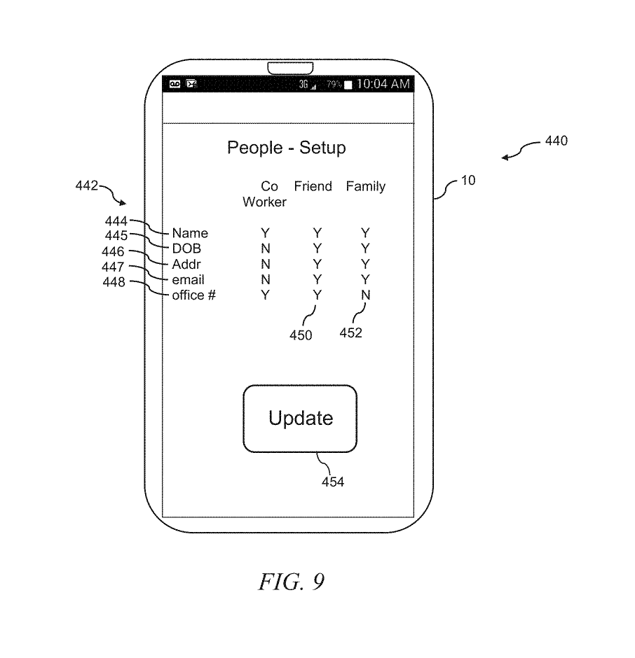

It is fully anticipated that the initiator has capabilities to adjust settings controlling what contact data is provided under each of the co-worker 432, friend 434, and family 436 directives. For example, some users will provide their cellular number to coworkers. This customization is made, for example, with a set-up user interface 440 as shown in FIG. 9. In this, the initiator is presented with a detailed list 462 of contact data and, for example, the “Yes” directives 450 and “No” directives 452 for each of the detailed list 462. The detailed list 462 shown in this example is shortened to five categories of contact data for clarity reasons: name 444, date-of-birth 445, address 446, email 447, and office phone number 448. For each of the desired categories, selections are made as to whether that desired category is to be included in the categories (co-worker 432, friend 434, family 436). For example, a Yes directive 450 in the intersection of allergies 448 and the friend column indicates that when contact data is shared with a friend, allergy data is included. A No directive 452 in the intersection of allergies 448 and the family column indicates that when contact data is shared with a family, allergy data is excluded.

Although only three categories (co-worker 432, friend 434, family 436) are shown, any number of categories is anticipated, including none. Other categories include, but are not limited to, clients, doctors, contractors, businesses, lawyers, etc. In some embodiments, the user has features for creating new categories or renaming existing categories. It is fully anticipated that user interfaces are presented showing contacts for selection and used (e.g., sending email, making phone calls). In some embodiments, all contacts are shown in a single navigable list. In some embodiments, contacts are sorted by categories and shown in individual lists for each category, etc.

In some embodiments, the initiator has the ability to rename or add directives suitable to their needs. This is performed using typical user interface operations of the smartphone 10, such as, overwriting the existing column headings.

For situations in which the initiator wishes to provide specific contact information to the recipient that does not fall into a pre-determined category (e.g., co-worker 432, friend 434, family 436), the initiator selects the custom directive 439 and is presented with the custom contact share user interface 460 shown in FIG. 10.

In the custom contact share user interface 460, the initiator has a detailed list 462 of contact data and, for example, “Yes” directives 450 or “no” directive 452 for each of the detailed list 462. The detailed list 462 shown in this example is shortened to five categories of contact data for clarity reasons: name 464, date-of-birth 465, address 466, email 467, and office phone number 468. Once the desired categories are selected from the detailed list 462, the initiator selects the connect 461 to connect contact information with the recipient. The initiator has the ability to cancel with the cancel directive 463.

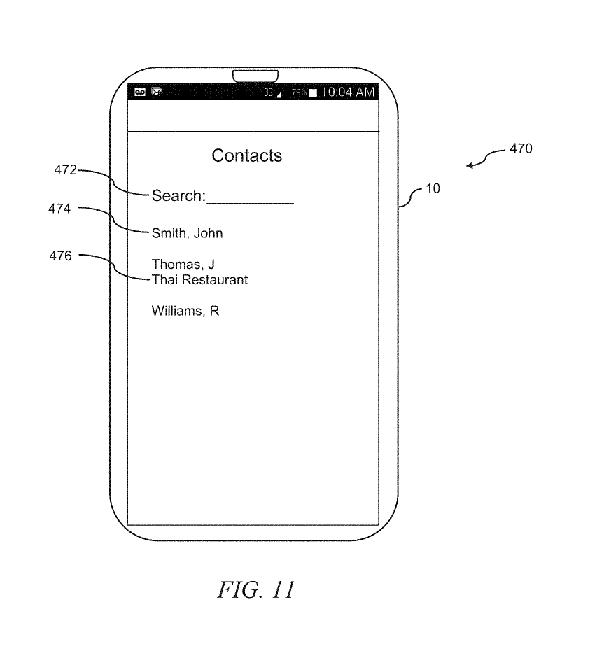

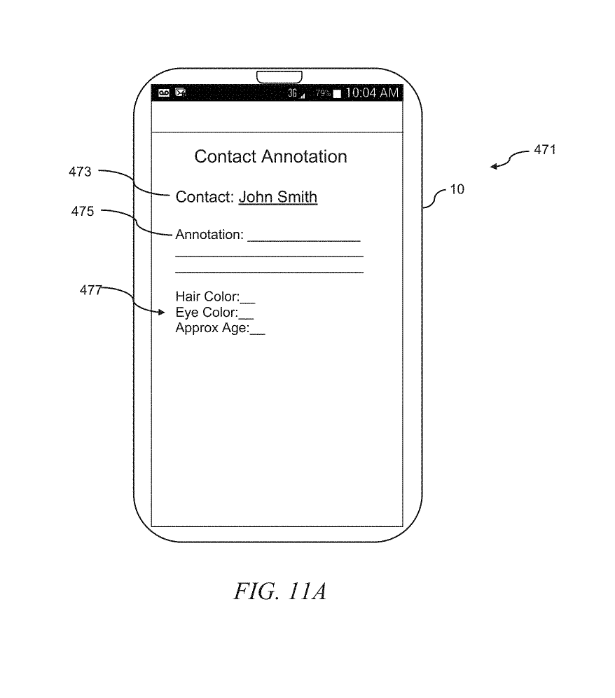

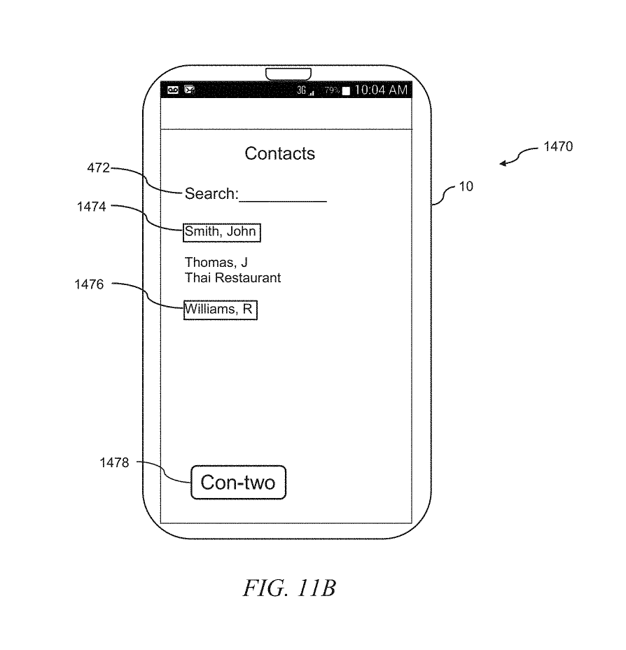

Once the recipient accepts the contact data, the portion or all of the initiator's contact record 520 is entered into the recipient's contact list 470 as shown in FIG. 11. Note that in this example, there is only one entry for John Smith 474 and only one entry for the Thai Restaurant 476. Since there can be at most one entry per phone number, only one contact record 520 is allowed per phone number.

In some embodiments, the system for common contact management permits annotation of other's contact records. Annotation information is any data provided by the recipient of the contact record that is entered by the recipient and thereafter associated with the contact record but held privately for the recipient. By this, the annotation information is accessible only by the recipient, not by the initiator.

In the exemplary annotation user interface 471 of FIG. 11A, the user has selected a contact (John Smith), for example by tapping on the contact in the list of FIG. 11. The name 473 associated with the contact is displayed and, in some embodiments, other information is displayed that has been made available from the contact record of this user (e.g., phone number, address). The annotation user interface 471 enables a user to annotate the record for another individual, either using free-form annotation fields 475 or pre-determined annotation fields 477. The data entered in the free-form annotation fields 475 and/or pre-determined annotation fields 477 is uploaded to the server 500 and stored in the data storage 502. When the user accesses the system for common contact management, for example, on another device (e.g., on their desktop computer or tablet), the annotation data 475/477 is available and displayed for this contact (John Smith). In this way, the annotation data is distributed across all platforms used by this user. Further, the user has the ability to search the contact records by information in the annotation data 475/477. For example, if the user adds annotations for hair colors and eye colors to their annotation data 475/477 of others, then the user has the ability to search for all contacts having brown hair and brown eyes. Another example is to add a company name (AT&T, IBM, Dell . . . ) and the user has the ability to search for all contacts having an association with one of the companies.

In some embodiments of the system for contact management, users have the ability to suggest that two of their contacts share contact information. This provides each of the two contacts a notice that the other of the two contacts is interested in sharing contact information. An exemplary user interface for connecting two contacts 1470 is shown in FIG. 11B. In this, the user has selected two contact 1474/1476. Once the two contacts 1474/1476 are selected, the user operates the connect-two directive 1478 and both users receive accept user interfaces 420/420A. In one embodiment, each user receives accept user interfaces 420A in which the reason 423 is that the initiating user suggests they connect.

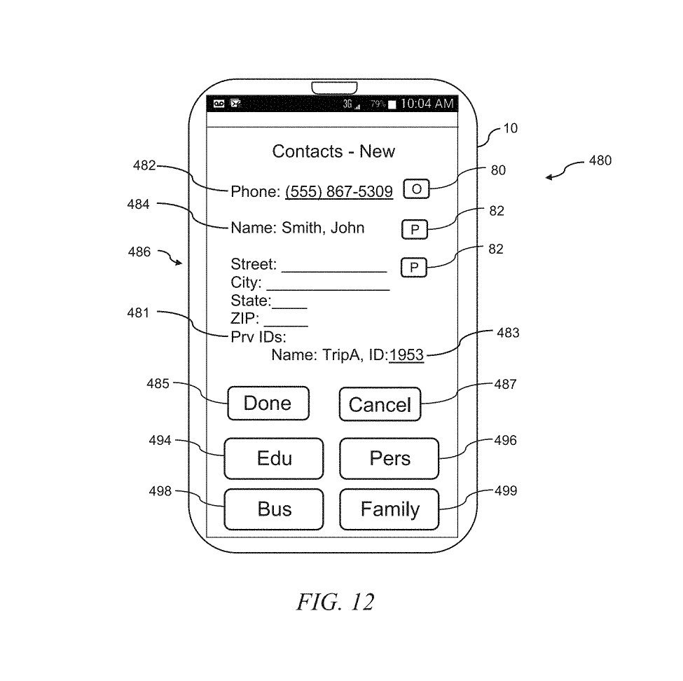

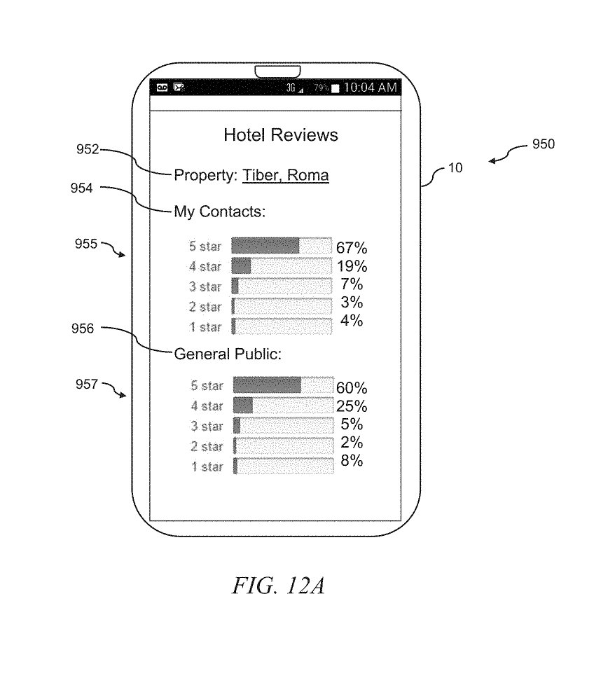

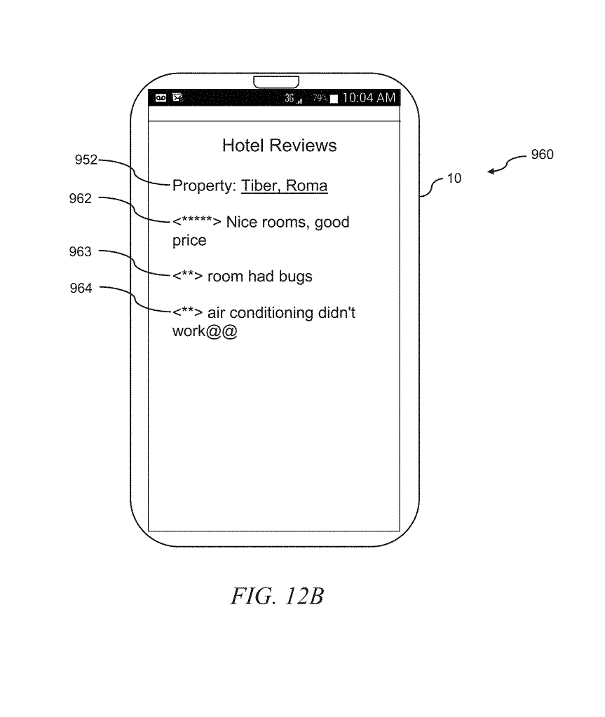

When first using the smartphone application of the system for common contact management, a user must establish minimal contact information using a contact creation user interface 480 as shown in FIG. 12. Note that in some embodiments, a subset of the inputs is required when creating a new contact. The phone number 482 of the contact must be entered, as that is the key for the contact records 520 (see FIGS. 13, 13A, 13B). In addition, the name 484 associated with that phone number 482 is likely required. This is the name of the owner of the phone number, either a person (e.g. John Smith) or and establishment (e.g. Thai Restaurant). Further information 486 is entered to complete the contact entry such as address. A cancel directive 487 is provided to abort contact entry.

In some embodiments, the phone number 482 is extracted from the device (e.g. smartphone 10), for example by reading the SIM card 88. This inherently provides some level of security and assurance that the phone number 482 is correct and a real phone number. In some embodiments, other verifications are made through US mail, text messages, email, etc. For example, a post card with a secret code is mailed to the address given, a text message with a secret code is sent to the phone number 482, a voice call is made to the phone number 482, an email with a secret code is sent to the email address provide, etc. The user must enter the secret code to activate their contact record 520.

After the initiator has entered all required and whatever optional data is desired, the initiator selects the “done” directive 485 to save the contact record 520 and upload the contact record 520 to the server 500 for storage in the data storage 502.

In some embodiments, a “global” directive 80/82 is associated with each field in the contact creation user interface 480 (and sub-user interfaces). The “global” directive 80/82 provides the ability for the user to make certain data of the contact record 520 available to all user of the system for common contact management, much like putting that information in the white pages of a paper phonebook. In the example of FIG. 12, the phone number 482 is open 80, the name 484 is private 82 and the address 486 is private 82. By selecting (e.g., touching, clicking) the open 80, the open 80 changes to private 82. By selecting (e.g., touching, clicking) the private 82, the private 82 changes to open 80. In making information global, the user is able to control what others can search and, once the user is found by another user, the another user then can request a connection to the user. For example, a user that is new in town searches for others who enjoy volleyball. Records of users who have “volleyball” in the hobby/interest field 521A (see FIG. 13) and have indicated that the hobby/interest field 521A is open 80 are displayed so that the user can request a connection to one or more of those returned from the search. Likewise, a user who is interested in dating another user searches for certain attributes (likes, education, marital status, etc.). A list of other users that have made such attributes globally open 80 is returned for review and possible requesting of connection.

In some embodiments, the contact creation user interface 480 includes directives for entering certain data that is never directly shared with other contacts, for security reasons. One such data is a private identifier 481, shown in this example having a single identifier 483 named TripA with a value of 1953. Again, the private identifier 481 is not typically shared with other users, but, as will be shown, a trusted-entity will have the ability to query the system for common contact management to obtain a list of private identifiers of those in the user's contact list. One use for this feature is honing a list of reviewers based upon those in the user's contact list. For example, if the user visits the website for the entity, TripA, and wants to read reviews for a certain hotel in San Francisco, the user will have a feature at that website to obtain reviews based upon their contact list. For example, the user will have the ability to obtain reviews created by everybody on that user's contact list or created by those in the family and friends subset of that user's contact list. To implement this feature, the user's phone number (or other key) is sent to the website, optionally with a subset identifier (e.g. family and friends). The website, being a trusted entity, queries the system for common contact management providing as input the user's phone number (or other key) and, optionally, the subset identifier. The system for common contact management returns a list of all private identifiers 481 from each contact record of other users that are in the user's contact list. Note, for privacy reasons, it is assumed that, in some embodiments, only the private identifiers 481 are returned without associations to the other user's name. Having the list of private identifiers 481, the website presents to the user only reviews from reviewers identified by the list of private identifiers 481 from each contact record of other users that are in the user's contact list. In this way, the user sees only reviews of those who the reviewer at least knows.

Although, in some embodiments, a scrolling list of all possible data entry fields for the new contact is presented, in the embodiment shown, additional data entry is segmented into categories. The categories include, for example, education data 494 (e.g., schools, colleges, experience); personal data 496 (e.g. food likes, dislikes, hobbies, etc.); business information (e.g., business phone, business address, business room number, business cellular number, etc.); and family information 499 (e.g. parent names, children, contact numbers, etc.).

By having a unique contact record for each phone number, when an initiator updates date in their contact information using a similar interface to that in FIG. 12 (e.g. changes their email address), the master contact record 520 is updated in the storage 502. Thereafter, whenever a recipient connects to the server 500, updates to the contact record 520 of the initiator are downloaded and cached in the recipient's contact database. Further, if the initiator decides to redact their contact information from the recipient, whenever the recipient connects to the server 500, the contact record 520 of the initiator is deleted from the recipient's phonebook.

By having unique correlations between phone numbers and users, in particular people who are associated with the phone numbers, unique capabilities are anticipated. One such unique capability is user feedback/ratings. Many websites gather rating information for goods and services. For example, a travel web site maintains detailed reviews of travel destinations and hotels. Each reviewer provides a rating (e.g. one to five stars) and a written review. To gain credibility, before being able to provide review information, one must register with this travel web site. This prevents some radical reviews and adds some credibility and traceability to each review, but a reader has no idea of the types of people that are providing the reviews. For example, one person leaving an “unclean room” review might have a much different opinion of what is clean than the reader of the review. By querying the system for common contact management, this travel web site is able to sort by reviews from people in your phone book, or display whether the reviewer is in your phonebook. Perhaps a review that you might trust appear on the top of the list or is highlighted in color. In some embodiments in which your contact list includes the type of contact information that has been allotted to you (e.g., friend, family), the review will indicate reviews from a family member or a friend, lending much more credibility to the review.

An exemplary review 950 of a fictitious hotel is shown in FIG. 12A. In this example, the property 952 is listed. Before presenting the review, the web site or application prepares the reviews by sending a query to the system for common contact management including identification information of the initiator. In one embodiment, the web site or application sends identification information of all reviewers for the property 952 and the system for common contact management responds with the identification information of only reviewers for the property 952 that are within the requestor's group (e.g., all that have shared contact information with the initiator, all that are in the same association 800—see FIG. 13A). In some embodiments, the web site or application sends identification information of the system for common contact management and the system for common contact management responds with the private information of other users that are within the initiator's group so that the web site or application will then treat the reviews with the identification information differently (e.g. sort the review or only show the reviews that are written by those in the user's contact list.

In some embodiments, the identification information includes a list of phone numbers of all contacts that are currently shared with the user.

In the example of FIG. 12A, the web site now prepares and presents two review charts 955/957. The first review chart 955 (labeled “My Contacts” 954 in this example) shows how the requestor's contact have reviewed the property 952 while the second review chart 957 (labeled “General Public” 956 in this example) shows how all reviewers have reviewed the property 952. If the requestor proceeds to inspect individual reviews, the requestor has the ability to inspect all reviews or inspect only reviews of the requestor's group as in FIG. 12B (e.g., all that have shared contact information with the requestor, all that are in the same association 800—see FIG. 13A).

In the example of FIG. 12B, this user interface 960 shows three written reviews 962/964/066. Note that the third review 964 has special marking (“@@”) that has an exemplary indication showing that this reviewer is in the requestor's contact list.

In some embodiments, the requestor has features to request all reviews, to request reviews from only from those in the requester's contact list 700 (see FIG. 13), and/or to request reviews from only from those in the requestor's contact list 700 (see FIG. 13) and in the contact lists 700 of each user in the requestor's contact list 700 (e.g., a first level of indirection).

In addition, since the system for common contact management provides a level of security and trust, when a user of the system for common contact management writes a review, the web site hosting that review is able to tag that review with knowledge of the user who wrote the review.

It is also anticipated that the review feature be made available to any contact management system. For example, an interface (e.g., Application Program Interface—API) is provided by contact management systems that returns a list of phone numbers in the user's phonebook. An application that displays review data (e.g., as in FIG. 12A) calls this API to discover the list of phone numbers in the user's phonebook, then uses the list of phone numbers to present review data segmented by those in the user's contact list (e.g., the review data 955 of FIG. 12A). In this scenario, since there are no second-level capabilities (e.g., the API does not know the contact lists of each contact in the user's phone book), only one level of review lists is anticipated.

Another use of the contact data is direct marketing. If likes, dislikes, hobbies, etc., are included in each person's contact information, the first person has the ability to share contact information with a second person that is an establishment. For example, an initiator has detailed likes and dislikes concerning food—like fish, likes beef, dislikes pork . . . If the establishment is a restaurant and received a huge delivery of fish that will not keep for more than three days, that restaurant can direct market to the first person, perhaps offering a coupon that is good for tonight for a fish dinner or a free bottle of wine with the purchase of two fish dinners, etc.

In FIG. 13, an exemplary set of contact records 520 as stored in data storage 502 are shown. In this simplified example, only three contact records 520 are shown, a first record 520A for Julie Smith, a second record for Steve Smith 520B, and a third record 520C for a restaurant, Thai Bowl. Note that these contact records 520 contain all information that has been entered by the owner of the individual records 520A/520B/520C. As described above, when sharing a user's contact record with another, the initiator has directives for restricting which parts of the contact record is shared with the recipient. In the simplified contact record 520A shown in FIG. 13, each subset of data within the contact record 520A is selectively shareable with the recipient. For example, if the recipient is a business acquaintance, then the office phone number is shared, but perhaps the initiator does not want the recipient to have access to the initiator's personal cell phone number, home address, food likes/dislikes, hobbies, and family information. In another example, if the recipient is a family member, then the initiator's cell phone number, likes/dislikes, hobbies and family information is shared, but perhaps the initiator does not want the recipient to have access to the initiator's office phone number so as to not be interrupted at work by the family member.

A set of linkages are shown in FIG. 13 for one recipient 702 (e.g. John Smith). When a initiator allows a recipient access to some or all of the initiator's contact information, one way anticipated to track what portions of the initiator's contact information are accessible by the recipient is to maintain a set of linkages for each recipient (although a single set of linkages is shown for brevity reasons, any number are anticipated). In the example of FIG. 13, the recipient 702 has been provided access to two contact records 520A and 520C through two links 704/708. The first link 704 provides access to a first contact record 520C for Thai Bowl while the second link 708 provides access to a second contact record 520A for Julie Smith. In the first link 704, there is a flag or data value 706 indicating that all fields of the first contact record 520C are accessible by John Smith. In the second link 708, there is a flag or data value 710 indicating that only the phone number and address portions of the second contact record 520C are accessible by John Smith. Again, this is a simplified example and there are many types and combinations of flags or data values for the various subsets of the contact records.

Note that the contact record 520A shown in FIG. 13 includes a list of hobbies 521A. One such hobby is sky diving. In some embodiments, if the owner (Julie Smith) opts-in to targeted marketing, companies will have the ability to directly market products to the owner of the contact record 520A (Julie Smith). For example, the owner of the contact record 520A (Julie Smith) has opted-in and when a provider requests contacts for all users that have opted-in having a hobby of “sky diving,” that provider will receive a selected portion of the contact record 520A (Julie Smith). In some embodiments, the selected portion is restricted to the owner's name 523A and email address 527A. In some embodiments, the selected portion is restricted to the owner's phone number 525A. In other embodiments, other combinations or portions of the contact record 520A is sent to the provider for direct marketing to the owner of the contact record 520A (Julie Smith).

In some embodiments, the user has the ability to opt-in to allowing others to find that user using some or all data within the user's contact record 520. For example, if the user opts-in to allowing others to find them using their hobbies or current school, others having their own contact record 520 can request a connection to that user (e.g. through an interface such as 410/410A/410C as shown in FIGS. 5, 5A, and 7). This lets users with similar hobbies, organizations, values, likes, etc., find each other or find other organizations such as churches, joining a team, schoolmates, etc.

In FIG. 13A, an exemplary set of contact records 520 as stored in data storage 502 are shown. In this simplified example, only three contact records 520 are shown, a first record 520A for John Smith, a second record for Steve Smith 520B, and a third record 520C for a restaurant, Thai Bowl. Note that these contact records 520 contain all information that has been entered by the owner of the individual records 520A/520B/520C. In this example, an association list 800 is shown. An association is a list that each user directly or indirectly opt into. By directly, the user makes a request to be added to the association list 800, for example by requesting inclusion through an administrator of the association list 800. By indirectly, the user is added to the list 800 by joining an organization. In the example of FIG. 13A, two users are part of an association 802 (Alpha Beta Psi), for example, members of a fraternity, employed by a company, etc. As shown, the list 800 includes a first link 804 corresponds to the contact record for Steve Smith 520B and a second link 806 corresponds to the contact record for John Smith 520A. It is anticipated that a typical association list 800 will include many links to contact records 520 as any number is anticipated. It is also anticipated that an administrator be assigned having privileges to add and remove links 804/806 to/from the association list 800.

Another use for the association list 800 is to group contact records 520 that have a common bond. For example, if the individual establishments within a mall each have contact records 520, then an association list 800 is created with links 804/806 to each of the individual contact records 520 of the individual establishments. Having such association lists 800, the user interface initially shows information regarding the mall (e.g., a contact for the mall) but as the user approaches the mall (e.g., as determined by the reading the GPS subsystem 91), the user interface expands showing each of the individual establishments. As the user enters the mall, the user interface further expands showing the individual establishments that are near the user. When the user enters one of the establishments, the user interface includes details of the products and any special offers currently running.

In FIG. 13B, an exemplary set of contact records 520 as stored in data storage 502 are shown. In this simplified example, only three contact records 520 are shown, a first record 520A for John Smith, a second record for Steve Smith 520B, and a third record 520C for a Terry Smith. Note that these contact records 520 contain all information that has been entered by the owner of the individual records 520A/520B/520C. In this example, a family association is shown using a pair of association tables 900/920. A family association is an inherited association through declaration that one user (e.g. spouse-1 902) is related to and has access to some or all contact records of another user (e.g. spouse-2 922). For clarity reasons, the example shown uses a spousal relationship, though any family relationship of other inheritance is anticipated using the same, different, or similar structures. For example, a child is the first user and a parent is the second user. The parent has access to all the contacts of the child should the parent need to contact one of those contacts, for example, to arrange carpooling or if there is an emergency. In this scenario, it is likely a one-way relationship, in that the parents contacts are not visible to the child, while in a spousal relationship, it is likely a two-way relationship where each spouse has access to the other spouse's contacts.

In some embodiments, the giving family member has the ability to exclude certain contacts from the receiving family member's list. For example, one spouse may exclude business contacts from the other spouse or a child may provide access to a parent of only some contacts, but not dating contacts.

In the scenario shown, spouse-1 902 has provided access for two contact records 520A/520B to spouse-2 922. In the list 900 for spouse-1 has access to two contact records 520A/520B through a first list element 904 for Steve Smith and a second list element 906 for John Smith. Note, it is fully anticipated that the list elements 904/906 include flags or data values 706/710 as shown in FIG. 13, which are not shown for brevity and clarity reasons. The first user, spouse-1 902, has allowed access to his/her contacts by declaring the second user, spouse-2 922 a spouse (or other significant other). In making such a declaration, the second user, spouse-2 922 gains access to both contact records 520A/520B through a first link 924 to element 904 (Steve Smith) and a second link 926 to element 906 (John Smith). By providing the links 924/926, the second user, spouse-2 922 has access only as long as the first user, spouse-1 902, has access to those contact records 520A/520B along with any restrictions to access of those contact records 520A/520B enforced by flags or data values 706/710 as shown in FIG. 13.

The list 920 for the second user, spouse-2, includes an additional link 928 that corresponds to a contact record 520C for Terry Smith. In this scenario, the second user, spouse-2 922, has not declared the first user, spouse-1 902, as a spouse and, therefore, the additional link 928 that corresponds to a contact record 520C is not accessible by the first user, spouse-1 902 until for the second user, spouse-2, declares the first user, spouse-1 902, a spouse.

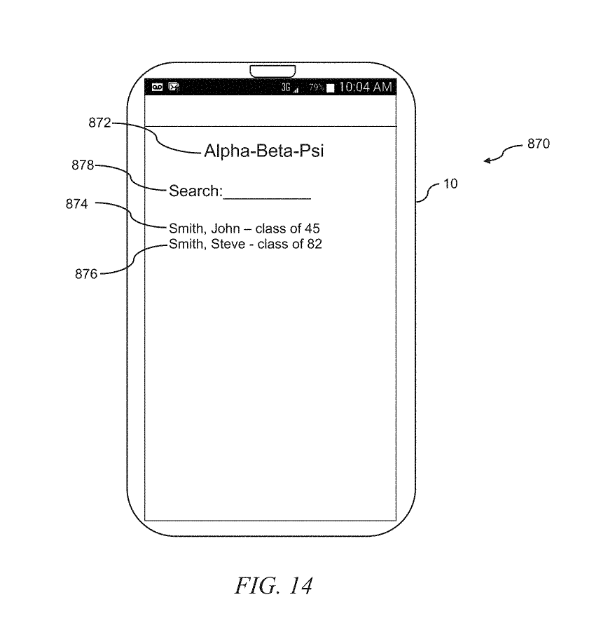

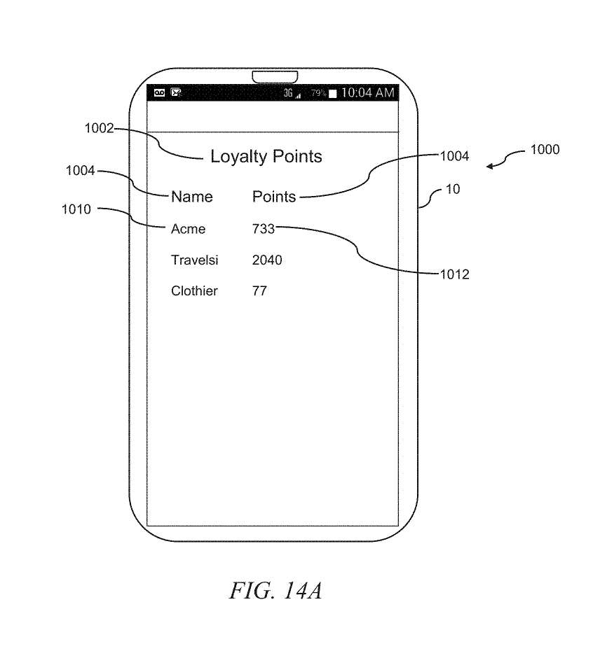

As with the association contacts as described in FIG. 13A, it is anticipated that in some embodiments, linked contacts be partitioned into separate or sub-phonebook lists as shown in FIG. 14, as, for example, another family member may have a huge number of contacts that the first family member does not want included in their primary phonebook. It is also anticipated that other contact sorting is performed based upon categories, folders, type of contact, etc.

In FIG. 14, an exemplary user interface for displaying/searching contacts 870 of the system for common contact management is shown. If a user is a member of an association (e.g., an organization, a group, a list of users), the user has access to contact records 520 for each member identified in the association. In this exemplary user interface for displaying/searching contacts 870, the association 872 is displayed on the smartphone 10 (Alpha-Beta-Psi) and the members of the association are displayed (for brevity reasons, only two members 874/876 are shown). In some embodiments, a search field 878 is provided for the user to enter search criteria such as name, year graduated, or other attributes.

In some embodiments, the association lists are selected through a user interface of the phone contact management interface 470 (see FIG. 11) through, for example, drop-down lists, swiping of a touch screen to the left or right, or any way known in the industry. It is anticipated that a user is a member of no associations, one association, or any number of associations.

In FIG. 14A, an exemplary user interface for displaying loyalty points 1000 of the system for common contact management is shown. Many retailers, hotel chains, airlines, service providers, etc., reward their clients with loyalty points that are typically redeemable for products, travel, hotel stays, etc. In the past, each retailers, hotel chains, airlines, service providers, etc., had their own system for managing, tracking, and reporting the loyalty points. As the system for common contact management includes a unique identity for each user (e.g., a single contact record 520 per user), enabling the system for common contact management to manage some or all of loyalty point management. For example, when a user of the system for common contact management enters a retail location, using the GPS subsystem 91 of the user's device (e.g., smartphone 10), the system for common contact management knows that the user is at that specific retail location and, per algorithms pertaining to that retailer, the system for common contact management calculate loyalty points for visiting the retailer, even when no purchase is made. In another example, another application operating on the user's device notifies the system for common contact management of an activity or location of the device. For example, such application recognizes an image capture of a special logo identifying a service and participant in that service.

The loyalty points are accumulated, along with loyalty points earned for purchases. In FIG. 14A, the exemplary user interface for displaying loyalty points 1000 displays a user's loyalty points 1004 for several organizations sorted by name 1004 (e.g., name of the retailer, company, service, etc.). For example, the user has 733 points 1012 for the retailer named, “Acme” 1010.

In FIG. 15, a connected diagram is shown with multiple devices 10A/106/10C connected to a single data record 520D, stored in the storage 502. The record 520D in the storage 502 contains all information entered regarding this phone number (e.g. 555-867-5309). Three devices 10A/106/10C are shown for brevity reasons, as any number of devices 10 are anticipated.

Being that the contact record 520D contains all information regarding the user associated with that phone number, no direct access to the contact record 520D is allowed. Instead, when the initiator provides contact information to the recipient, only the information allowed by the initiator (e.g. a partial contact record 520E stored in the memory 74 of the smartphone 10) is cached into the recipient's device 10A/106/10C. Therefore, although each device 10A/106/10C share some common information from the contact record 520D, some of the devices 10A/106/10C will have more or less information from the contact record 520D. For example, each device 10A/106/10C has name and address information, but two smartphones 10A/10B (e.g. parents of the owner of contact record 520D) will have total access to all information.

In this example, the contact record 520D includes several annotations 475A/475B/475C entered by three different users. The user of the first user device 10A had annotated this contact record with an annotation 475A as described previously and the annotation is associated (or stored) with the contact record 520D. When the first user access this contact record 520D, that user also has access to the annotations 475A for that contact record 520D, even when that user access this contact record 520D from a different device such as a desktop, laptop, or tablet computer.

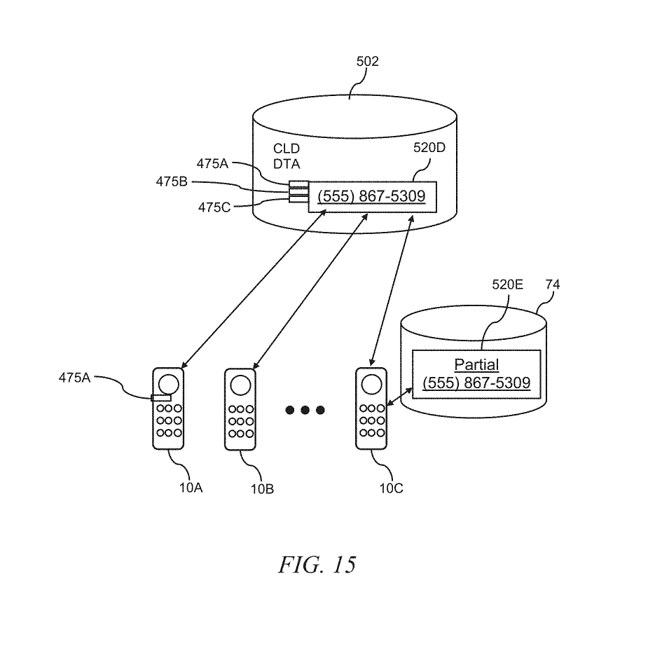

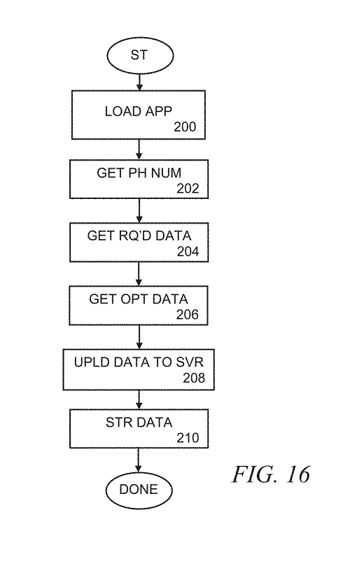

Referring to FIGS. 16-19, exemplary program flows of the system for common contact management are shown.

It is anticipated that portions of the exemplary program flow execute on a user device such as a smartphone 10 while portions of the exemplary program flow execute on the server 500.

In this example, starting with FIG. 16, the flow starts when the initiator creates or modifies their contact record 520, as for example, using an interface such as the new contact user interface 480 shown in FIG. 12. The smartphone application is loaded 200, as known in the industry. The application starts by obtaining 202 the phone number 482 of the smartphone 10 (or other device). For many devices with assigned phone numbers (e.g. smartphones 10), the application reads the phone number 482 from the operating system of the smartphone 10, For setting up a contact record 520 for other devices such as land-lines, the initiator enters the phone number 482 using, for example, an on-screen numeric keypad 416. Next, data is inputted 204/206, including inputting required data 204 (e.g. the name 484 and address 486) and inputting optional data 206 (e.g. email, date of birth, work information), if any. Once all data has been entered, the initiator selects the “done” directive 485 and the contact record 520 is uploaded 208 to the server 500 and the server stores 210 the contact record 520 in the storage 502.

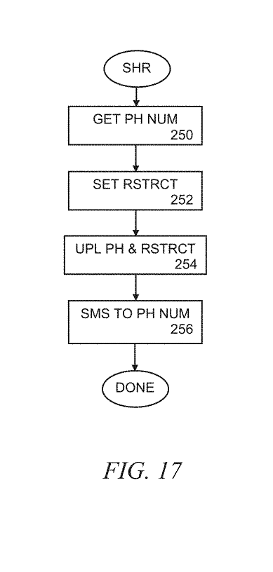

When the initiator shares some or all of the initiator's contact record 520 with a recipient (as in FIGS. 5 and 7-10), the first step (as shown in FIG. 17) is to obtain 250 the phone number 482 of the recipient. Next, if restrictions are desired or if a specific category of recipient 432/434/436 is selected, a set of restrictions are set 252. Next, the phone number 482 and set of restrictions are uploaded 254 to the server 500 and stored in the storage 502. Later, when the recipient access the server 500, the recipient's phone number 482 is compared to the stored phone number 482 to determine permissions and which data within the contact record 520 is allowed to be downloaded to the recipient.

Now a message is sent 256 to the recipients phone (e.g. an SMS to the phone number 482). This message (e.g. text, SMS) is either viewed by the recipient (if the recipient has not yet loaded the application) or is received by the application to present the connection user interface 420 as in FIG. 6.

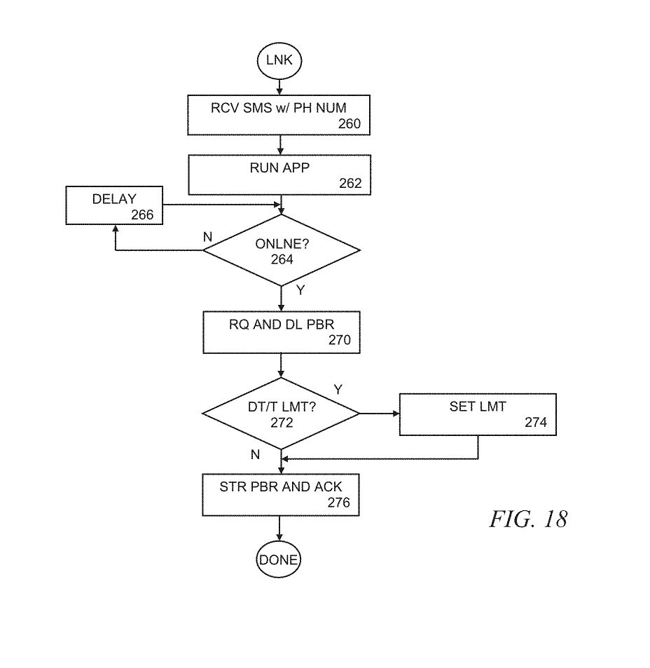

In FIG. 18, it is shown what happens at the recipient's smartphone 10. The message is received 260 and the application runs 262. A test is performed to determine if the recipient's device is online 264 (e.g. has connectivity to the server 500 through the internet 506 and/or cellular network 68). If the device is not online 264, a delay 266 is performed and the test is performed again until it is determined that the device is online 264. Once online 264, a request 270 is sent to the server 500 and information from the contact record 520 is downloaded 270. If the information from the contact record 520 includes a deletion date 272 (e.g. the recipient will lose access to the information from the contact record 520 on Friday), a limit is recorded 274 in the application so that, when the date/time arrives, the application will delete the information from the contact record 520.

The information from the contact record 520 is stored 276 (e.g. cached and made accessible by the recipient's phonebook application) and an acknowledgement is sent to the initiator.

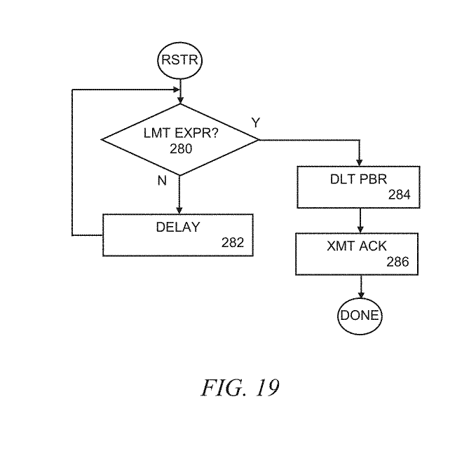

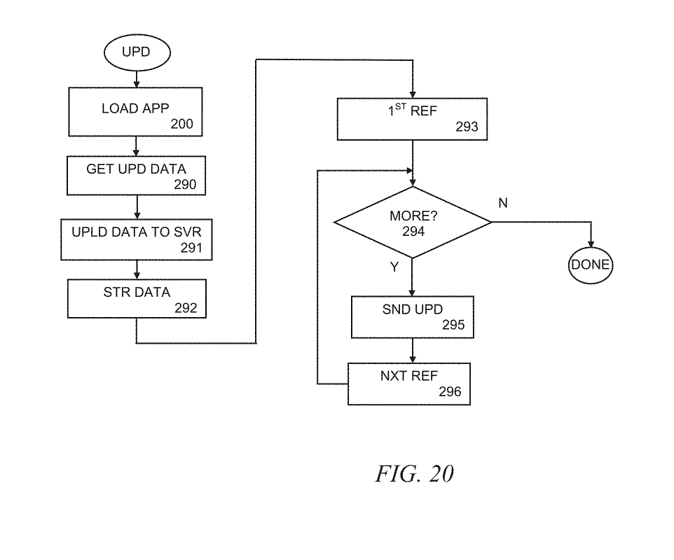

In FIG. 19, when the information from the contact record 520 includes a date limit 272 (e.g., the recipient can only access the information from the contact record 520 until Friday), the limit was is recorded 274 in the application. Within the application running on the recipients device (e.g. smartphone 10), a test is made 280 to determine if the limit has occurred. If the limit has not occurred, a delay 282 is taken and the test is repeated. If the limit has occurred (e.g. it is Friday), the application will delete 284 the information from the contact record 520. In some embodiments, an acknowledgment of the deletion is transmitted 286 to the initiators smartphone 10, the server 500, or both.

FIG. 16 shows an exemplary flow when a user updates their contact information. When the initiator creates or modifies their contact record 520, as for example, using an interface similar to the new contact user interface 480 shown in FIG. 12, the smartphone application is loaded 200, as known in the industry. The application starts by obtaining 290 updates to data or changes to restrictions. Once all changes have been entered, the initiator selects the “done” directive 485 and the changes are uploaded 291 to the server 500 and the server stores 292 the updates in the contact record 520 in the storage 502.

Now, the updated contact record 520 or changes are sent to all other users that have access to the contact record 520. A loop starts with loading information (e.g. phone number) of a first user that references the contact record 520. If there are no more users 294 referencing this contact record 520, the loop terminates. If there are more users 294 referencing this contact record 520, an update is sent 295 the that user then the next users 294 referencing this contact record 520 is determined 296 and the loop repeats. This assures that when a user makes a change to their contact record 520 (e.g. changes an email address), all other users that have access to that user's contact record 520 receive updates.

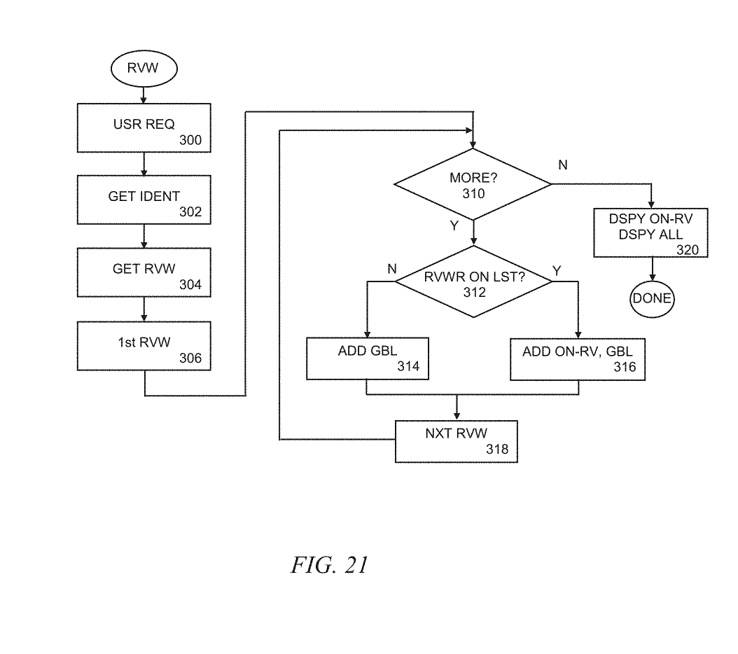

FIG. 21 shows an exemplary program flow for generating reviews that are sorted by those on one's contact list. The flow starts with a user making a request 300 of a web site or an application (e.g., an application running on a device such as a smartphone 10, a personal computer, and a tablet). The web site or application issues a request for identification 302 of those on the user's contact list. In some embodiments, the request is made through an API or other programmatic interface. The request returns a list of identifications such as a list of phone numbers from the user's contact list (e.g., standard smartphone contact list) or contact records 520 as described above.

In some embodiments in which the contact list is also known for each member of the user's contact list, optionally, the API or other programmatic interface returns a larger list of identifications including identifications of each of the user's contacts along with identifications of each of the contacts of each of the user's contacts, providing a second level capability. For example, if the requester wants to see all reviews sorted by their own contact, or at a different time, see all reviews sorted by their own contacts and all contacts of their own contacts (e.g., 2^{nd} level indirection).

Now the web site or application issues a request for all reviews 304 of a selected product, service, property, etc. This returns, for example, star-ratings from many reviewers of the selected product, service, property, etc. Now, the first review is selected 306 and a loop begins.

The first step in the loop is to determine if there are more reviews 310. If there are more reviews 310, then the current review is tested 312 to see if the reviewer is on the list of identifications. In this example, if the test 312 indicates that the reviewer is on the list of identifications (e.g., the reviewer has a phone number that is in the list of phone numbers), then the review is added to both 316 an on-list and a global list. In this, the reviewer's star rating is counted in the list for both those that are in the list of identifications and in the list of all reviews of the selected product, service, property, etc. If the test 312 indicates that the reviewer is not on the list of identifications (e.g., the reviewer has a phone number that is not in the list of phone numbers), then the review is added 314 to the global list. In this, the reviewer's star rating is counted only in the list for all reviewers and not in the list of those that are in the list of identifications.

Now the next review is selected 318 and the loop continues checking if there are more reviews 310. If there are no more reviews 310, the web site or application displays 320 either or both lists of reviews, for example as one or two bar graphs (as in FIG. 12A), a list of reviews, etc.

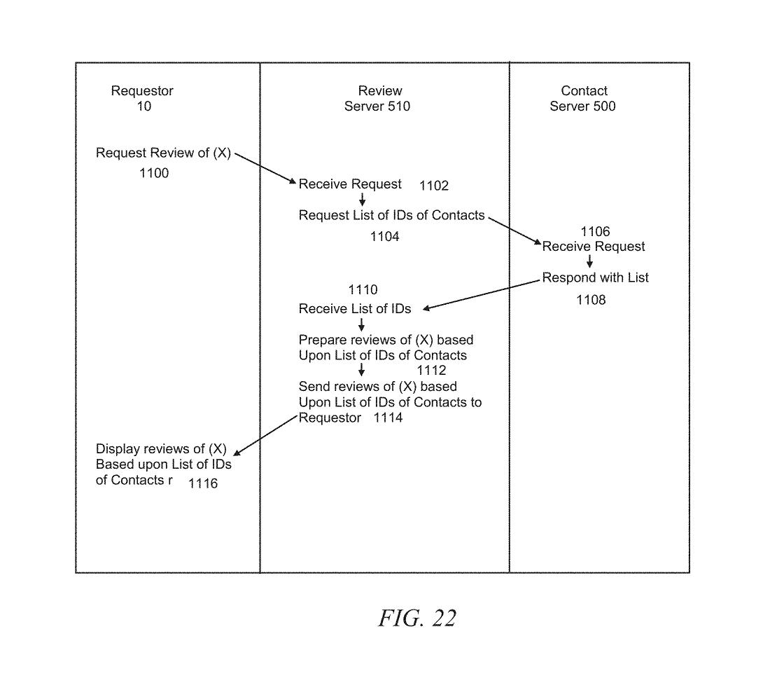

Referring to FIG. 22, a transaction flow diagram is shown using the system for common contact management in conjunction with a system having reviews to provide reviews related to those in the requestor's contacts. In this transaction flow, the requestor (e.g. the smartphone 10) requests 1100 to see reviews from a review server 510 (e.g. a server of a company that provides reviews such as a travel and lodging web site). The review server 510 receives the request 1102 and request a list of IDs of the contacts of the requestor 1104. It is anticipated that the requestor send identifying information to the review server such as the requestor's phone number.

The server 500 of the system for common contact management receives this request 1106 and responds 1108 with a list of IDs from those who are on the requestor's contact list. For example, many review servers 510 require reviewers to identify themselves to assure the quality of the reviews. In order to create a review, the reviewer must provide their ID or other identifying information. This ID is stored in each reviewer's contact information accessible by the server 500.

The review server 510 receives the list of IDs 1110 and prepares the reviews accordingly 1112, for example, providing a summary chart (as in FIG. 12A) or a sorted/limited/marked list of reviews indicating which reviews are from those on the requestor's contact list. The review server sends the prepared reviews 1114 back to the requestor and the requestor displays the prepared set of reviews 1116.

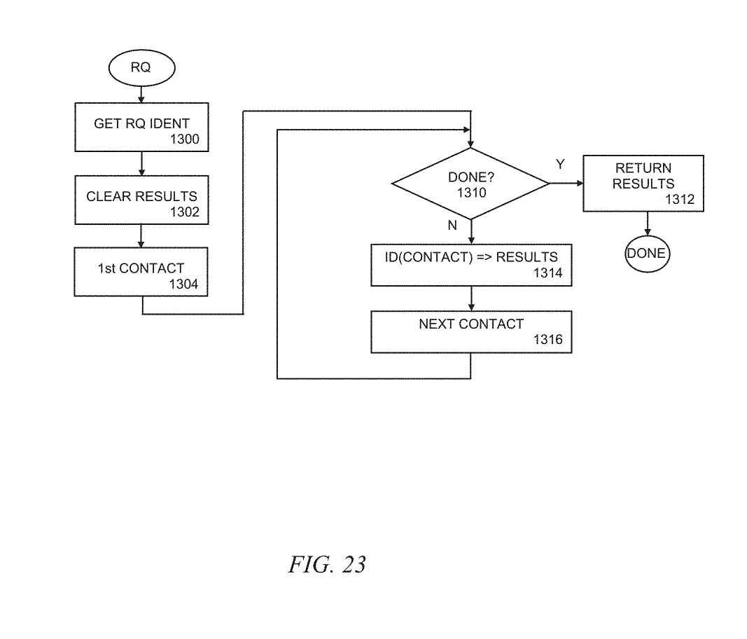

Referring to FIG. 23, a program flow diagram is shown for using the system for common contact management in conjunction with a system having reviews. In this exemplary flow, the system for common contact management receives a request from, for example, a review server. The request includes an identification of the requestor 1300 (e.g. the requestor's phone number). An output buffer for results is cleared 1302 and the first contact of the requestor is accessed 1304. If there are no more contacts for the requestor 1310 (e.g. the search is finished), the output buffer with the results is returned 1312 to the requestor (e.g. a list of IDs related to the review server from each contact from the requestor. If there are more contacts for the requestor 1310 then the ID of the current contact is added to the output buffer (results) 1314 and the next contact is accessed 1316 in a loop. The ID of the current contact is the ID related to the review server. For example, if the review server is a travel web service, then the ID is the ID for that travel service. It is fully anticipated that each contact record contain IDs for many different review servers as there are many services that allow users to write reviews of products, hotels, airlines, rental car companies, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for targeted reviews, the system comprising:
a requester device;
a sever for managing contacts, a server having a plurality of contact records, each contact record comprising identification data;
a review server having a plurality of reviews;
software running on the requester device accesses the review server and requests a subset of the reviews related to a subject;
the review server sends a query to software running on the server, the query requests a list of identification data from a subset of the plurality of contact records that are contacts of the requester device;
the software running on the server finds the subset of the plurality of contact records that are contacts of the requester device and responds by sending identification data from each contact record in the subset of the plurality of contact records that are contacts of the requester device;
the review server sends the requester device the subset of the reviews related to the subject processed using the list of identification data from each contact record in the subset of the plurality of contact records that are contacts of the requester device; and
the requester device displays the subset of the reviews related to the subject processed using the list of identification data from each contact record in the subset of the plurality of contact records that are contacts of the requester device.

2. The system of claim 1, wherein the review server sends the requester device the subset of the reviews related to the subject processed using the list of identification data from each contact record in the subset of the plurality of contact records that are contacts of the requester device along with reviews related to the subject from other reviewers, indicating which of the reviews are from the other reviewers.

3. The system of claim 1, wherein the review server sends the requester device a summary of the subset of the reviews related to the subject processed using the list of identification data from each contact record in the subset of the plurality of contact records that are contacts of the requester device.

4. The system of claim 3, wherein the review server also sends the requester device a second summary of all the reviews related to the subject.

5. The system of claim 1, wherein the identification data comprises an identification assigned by the review server to each contact.

6. The system of claim 1, whereas the requester device displays the subset of the reviews related to the subject processed using the list of identification data from each contact record in the subset of the plurality of contact records that are contacts of the requester device in graphical format.

7. The system of claim 1, wherein the requester device is a smartphone.

8. A method for targeted reviews, the method comprising:
a user at a device requesting a review related to a subject;
the device sending a request for the review to a review server through a network;
the review server requesting a list of identification data from a server having access to a set of contact records that are contacts of the user;
the server extracting the list of identification data from the set of contact records and sending the list of identification data to the review server;
the review server generating a subset of the review data related to the subject, sorted/marked/filtered according to the list of identification data; and
the review server sending the review data related to the subject according to the list of identification data to the device for display.

9. The method of claim 8, further comprising:
the review server further including review data related to the subject from other reviewers in the subset of review data after the review data related to the subject according to the list of identification data.

10. The method of claim 8, wherein the set of contact records that are contacts of the user is determined by a key received from the device.

11. The method of claim 10, wherein the key is a phone number of the user.

12. The method of claim 8, wherein the identification data comprises a user name known to the review server of a corresponding contact of the user.

13. The method of claim 8, whereas the step of the review server generating the subset of review data includes presenting the subset of the review data in graphical format.

14. Program instructions tangibly embodied in a non-transitory storage medium for providing targeted reviews, wherein the at least one instruction comprises:
computer readable instructions running on a requester device sending a request for a review related to a subject of a review server;
computer readable instructions running on the review server, after receiving the request for the review, sending the request for a list of identifications to a server having access to contact records related to the requester device;
computer readable instructions running on review server, after receiving the list of identifications, generating a subset of review data related to the subject and authored by contacts from the list of identifications and sending the subset of reviews to the requester device; and
computer readable instructions running on the requester device displaying the subset of the review data related to the subject and authored by contacts.

15. The program instructions tangibly embodied in the non-transitory storage medium of claim 14, further comprising:
computer readable instructions running on the review server creating a full set of the review data related to the subject, marked/sorted by contacts from the list of identifications.

16. The program instructions tangibly embodied in the non-transitory storage medium of claim 14, whereas the computer readable instructions running on the review server receive a phone number from the requester device and send the phone number in the request for the list of identifications.

17. The program instructions tangibly embodied in the non-transitory storage medium of claim 14, wherein the list of identifications comprises a list of user names known by the review server.

18. The program instructions tangibly embodied in the non-transitory storage medium of claim 14, wherein the list of identifications comprises phone numbers from the contact records related to the requester device.
